(19) United States
(12) Patent Application Publication
(10) Pub. No.: US 2005/0120272 A1
(43) Pub. Date: Jun. 2, 2005

(54) Systems and methods for determining bug ownership

(76) Inventors: Zachary Steven Smith, Fort Collins, CO (US); John Warren Maly, Laporte, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/712,572

(22) Filed: Nov. 13, 2003

(51) Int. Cl. G06F 11/00

(52) U.S. Cl. 714/38

(57) ABSTRACT

Disclosed are systems and methods for determining bug ownership. In one embodiment, a system and a method pertain to generating a database that contains database tokens that relate to identified bugs and that are associated with potential owners, generating input tokens associated with a bug in question, scanning the database for occurrences of the input tokens, and determining an overall probability of ownership of the bug in question for potential owners in the database.

### BACKGROUND

Various errors may be identified during the design of a program or during software-based modeling of a computer component (e.g., processor) design. Such errors may result from glitches in the program code at issue, which are often referred to as program “bugs.” Therefore, when a program operator receives such an error, it is common for the operator to investigate the error to determine if it was caused by a program bug.

When a bug is discovered, it is further common to log its discovery in a bug database that is used to track bugs from their discovery to their resolution. Such a bug database may include multiple bug records, each identifying a bug that was discovered, the date and time when each entry in the bug record was made, the circumstances under which the bug caused an error, who is believed to be responsible for fixing the bug (i.e., who “owns” the bug), and various information that describes the nature of the bug. By way of example, some of that information may be contained in a record header that provides a brief summary of the problem, and more detailed information may be contained in a body of the record. In addition to the operator's (i.e., entry submitter's) written description of the bug and the manner in which it was discovered, the submitter may further include a copy of an error message and/or a copy of data outputs that were received during the execution of the program.

If it is not clear who the owner of the bug is, the entry submitter may need to question several persons who are participating in the program and/or model design to obtain the information needed to make that determination. This process can be unduly time-consuming. Even when such efforts are made, the submitter's determination may still be incorrect. For instance, if it appears that the bug originates from a given block of code for which person A is responsible, it is possible that the true origin of the bug is a different block for which person B is responsible. In such a case, resolution of the bug may be delayed due to the incorrect identification of the bug owner.

In situations in which the entry submitter has little access to information about the bug and/or the owners of the various program blocks, the submitter may merely guess as to who the bug owner may be in making an entry in the bug database. Understandably, such guesswork does not yield consistent, accurate results.

### SUMMARY

Disclosed are systems and methods for determining bug ownership. In one embodiment, a system and a method pertain to generating a database that contains database tokens that relate to identified bugs and that are associated with potential owners, generating input tokens associated with a bug in question, scanning the database for occurrences of the input tokens, and determining an overall probability of ownership of the bug in question for potential owners in the database.

### BRIEF DESCRIPTION OF THE DRAWINGS

The disclosed systems and methods can be better understood with reference to the following drawings.

FIG. 1 is a block diagram of an embodiment of a computer system in which the disclosed systems and methods can operate.

FIG. 2 is a flow diagram of an embodiment of a method for determining bug ownership.

FIG. 3 is flow diagram of an embodiment of operation of a derivative database generator shown in FIG. 1 in generating a derivative database.

FIGS. 4A and 4B provide a flow diagram of an embodiment of operation of an ownership calculator shown in FIG. 1 in calculating a probability as to bug ownership using a derivative database.

FIG. 5A is table that conceptually illustrates the contents of a derivative database.

FIG. 5B is a table that conceptually illustrates the results of normalization of ownership probabilities as to particular input tokens.

FIG. 5C is a table that conceptually illustrates the results of scaling the results of FIG. 5B.

FIG. 6 is a flow diagram of an embodiment of a method of determining bug ownership.

### DETAILED DESCRIPTION

Disclosed are systems and methods for facilitating bug ownership determinations. In some embodiments, a system and method can be used to automatically generate a derivative database based upon information contained in a bug database, and automatically make a probability determination as to the ownership of a given bug based upon the derivative database. In such a case, a user (e.g., a bug entry submitter) can be provided with information that the user can use to make his or her own determination as to the true owner of the bug.

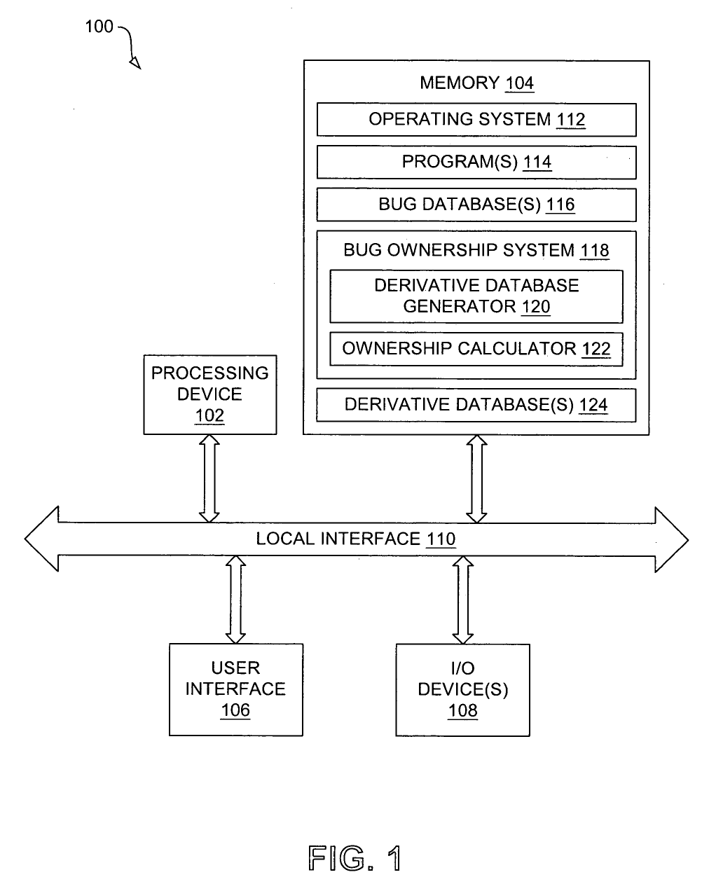

Referring first to FIG. 1, illustrated is an exemplary environment in which a bug ownership system and method may operate. More particularly, FIG. 1 is a block diagram of a computer system 100 in which a bug ownership system can execute and, therefore, a method for determining bug ownership can be practiced. As indicated in FIG. 1, the computer system 100 includes a processing device 102, memory 104, at least one user interface device 106, and at least one input/output (I/O) device 108, each of which is connected to a local interface 110.

The processing device 102 can include a central processing unit (CPU) or an auxiliary processor among several processors associated with the computer system 100, or a semiconductor-based microprocessor (in the form of a microchip). The memory 104 includes any one or a combination of volatile memory elements (e.g., RAM) and nonvolatile memory elements (e.g., read only memory (ROM), hard disk, etc.).

The user interface device(s) 106 comprise the physical components with which a user (i.e., operator) interacts with the computer system 100, such as a keyboard and mouse. The one or more I/O devices 108 are adapted to facilitate communication with other devices. By way of example, the I/O devices 108 include one or more of a universal serial bus (USB), a Firewire, or a small computer system interface (SCSI) connection component and/or network communication components such as a modem or a network card.

The memory 104 comprises various programs including an operating system 112 that controls the execution of other programs and provides scheduling, input-output control, file and data management, memory management, and communication control and related services. In addition to the operating system 112, the memory 104 comprises one or more programs 114 that may include bugs, and one or more bug databases 116 with which operators track the bugs discovered in those programs.

Further contained in the memory 104 is a bug ownership system 118 that is used to calculate probabilities as to who owns given, identified bugs. As is discussed in greater detail below, the bug ownership system 118 includes a derivative database generator 120 that is configured to automatically generate one or more derivative databases 124 from the one or more bug databases 116, and an ownership calculator 122 that is configured to calculate the probability of ownership of any input bug on an owner-by-owner basis.

Various programs (i.e., logic) have been described herein. Those programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

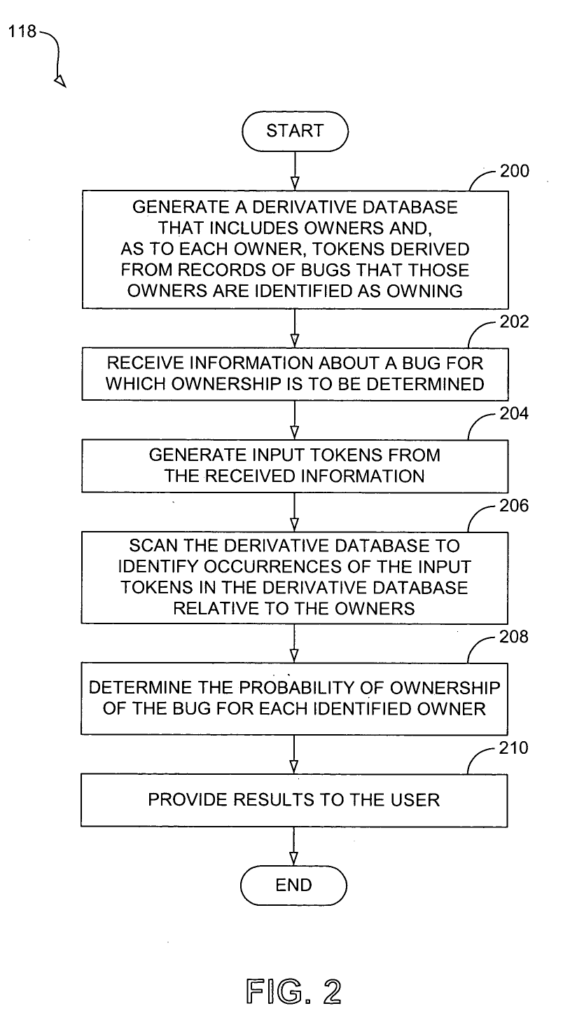

FIG. 2 provides an overview of an example method for determining bug ownership. More particularly, FIG. 2 provides an example of operation of the bug ownership system 118 in aiding a user in making a bug ownership determination. Beginning with block 200 of that figure, the bug ownership system 118 first generates a derivative database that includes various owners and, as to each owner, generates tokens that are derived from records of bugs that those owners are, at least provisionally, identified as owning. Once the derivative database has been generated, the system 118 can receive information about a particular bug for which ownership is to be determined, as indicated in block 202. Using that received information, the system 118 then generates input tokens, as indicated in block 204, that are used in the ownership determination process.

Once the input tokens have been generated, the bug ownership system 118 compares the one or more input tokens, which describe the bug in question, with the tokens contained in the derivative database (see block 200). Accordingly, as indicated in block 206, the system 118 scans the derivative database to identify the occurrences of the input tokens in the derivative database relative to the various owners that are identified in the derivative database. In addition, the number of times the input tokens appear in the derivative database relative to the owners is identified. Next, the system 118 determines the overall probability of ownership of the bug as to each owner, as indicated in block 208, so that the relative likelihood of ownership of the bug for owners of other bugs identified in the derivative database is determined. Once that determination is made, the system 118 can then provide the overall probability to the user, as indicated in block 210, to give the user an indication of who the most likely owner of the bug is.

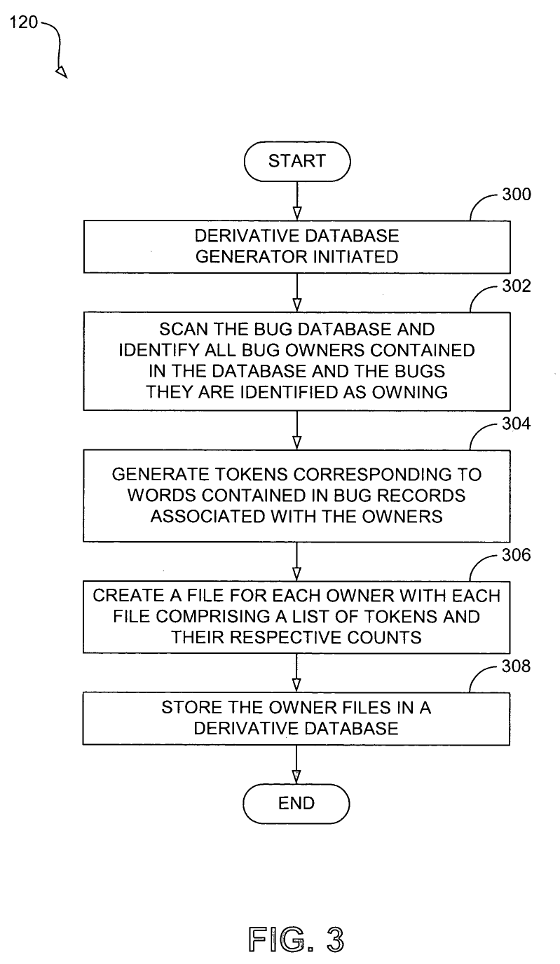

In view of the above, the bug ownership determination begins with generation of a derivative database (e.g., database 124, FIG. 1). As described in relation to FIG. 1, the derivative database can be generated by the derivative database generator 120. FIG. 3 provides an example of operation of the derivative database generator 120 in generating such a derivative database. Beginning with block 300 of FIG. 3, the generator 120 is initiated. This initiation can be automatic or can occur in response to a command received from an operator. In the former case, initiation may occur on a periodic basis. For example, the derivative database generator 120 may operate each day, for instance at night after all new entries have been made into the associated bug database, so as to use the most current bug data in generating the derivative database.

Once the derivative database generator 120 is initiated, the generator scans the bug database at issue and identifies all bug owners that are contained in the bug database, as well as each bug that those owners are indicated as owning, as indicated in block 302. As described above, the bug owners may be identified in information entered into the bug database by an operator (i.e., entry submitter). In that the submitter may not be certain about the true ownership of any given bug or may simply be incorrect as to that ownership, the ownership information identified in the bug database may be considered to be provisional determinations or guesses.

Next, the derivative database generator 120 generates tokens for each owner that correspond to character strings contained in the bug records associated with those owners, as indicated in block 304. Those strings may, for instance, comprise words contained within the bodies of the bug records that were created by the entry submitters. As noted above, such bodies may comprise the submitters' written descriptions of the bugs and the manners in which they were discovered, and/or copies of error messages and/or data outputs that were received during the execution of the program in which the bugs were found. In some embodiments, the tokens are only generated for “word-like” character strings to avoid creating tokens for miscellaneous keystrokes and/or commands that contribute little to the ownership determination. This may be accomplished by, for example, only generating tokens for character strings that comprise letters, numbers, and/or underscores. Such discrimination of the character strings results in filtering of spaces, tabs, periods, brackets, and the like that do not positively contribute to the analysis.

In addition to limiting the generation of tokens to such word-like character strings, tokens are not generated for character strings that comprise less or more than predetermined thresholds of numbers of characters. For example, in some embodiments, character strings that comprise less than 3 characters or more than 20 characters are disregarded such that tokens are not generated for those character strings. This form of discrimination results in filtering of small words that are unlikely to contribute to the analysis (e.g., words like “a,” “an,” and “it”), as well as large “words” that merely comprise data strings generated by the bug database interface.

With reference next to block 306, the derivative database generator 120 creates a file for each owner that was identified in the bug database. For purposes of simplifying identification of the files, the files can be given names that identify the owners to which the files pertain. For instance, each file can be given a name that incorporates an owner's login identification (ID). Associated with each owner file are the various tokens that were generated. In other words, the tokens generated from the bug records associated with each individual owner are associated with each owner's respective file. For example, if owner A was identified in the bug database as the owner of bugs 1, 2, and 3, and owner B was identified as the owner of bugs 4, 5, and 6, owner A's file will comprise the tokens generated from the records for bugs 1, 2, and 3, and owner B's file will comprise the tokens generated from the records 4, 5, and 6. In addition, the number of appearances of each token for each owner is noted. Therefore, if a particular token appears at least once for a given owner, the count for that token/owner combination is increased to equal the total number of times the token appears for the owner. For example, if the token “vector” appears three times for owner A, the entry for that token in owner A's file may comprise “vector 3” or equivalent. Optionally, control can be exercised over incrementing of the counts to avoid skewing the probability determination. For instance, a maximum increment amount can be used so that the count number as to any one owner's token can only be increased by a limited amount as to each bug. To cite an example, if the increment amount were capped at 20 and owner A had a first bug record in which token A appeared 25 times and a second bug record in which token A appeared 33 times, the count for token A only would be increased by 20 for each of the two bugs.

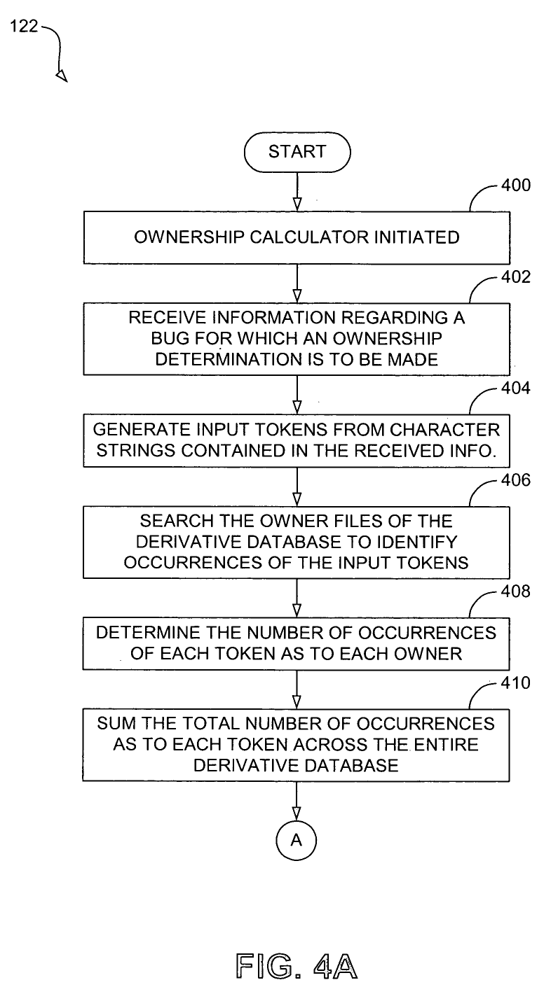

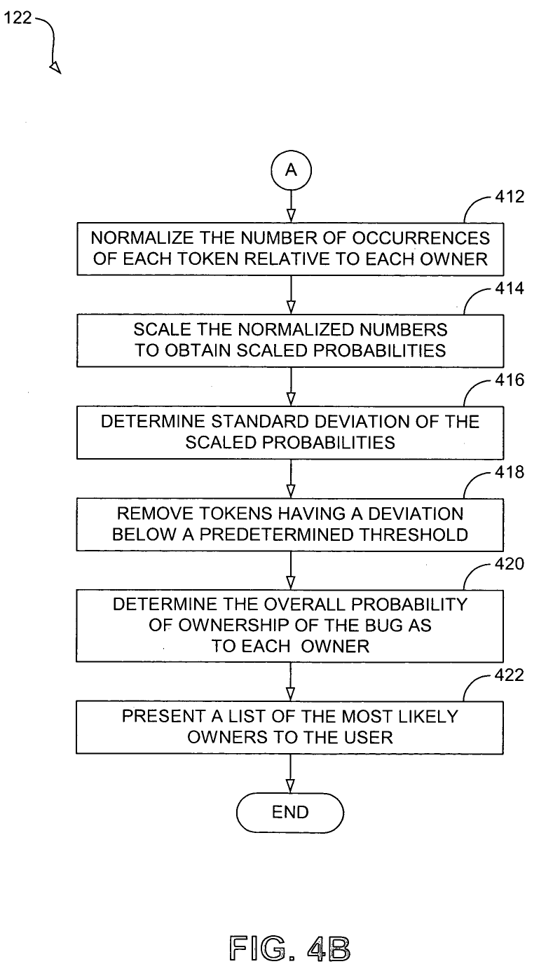

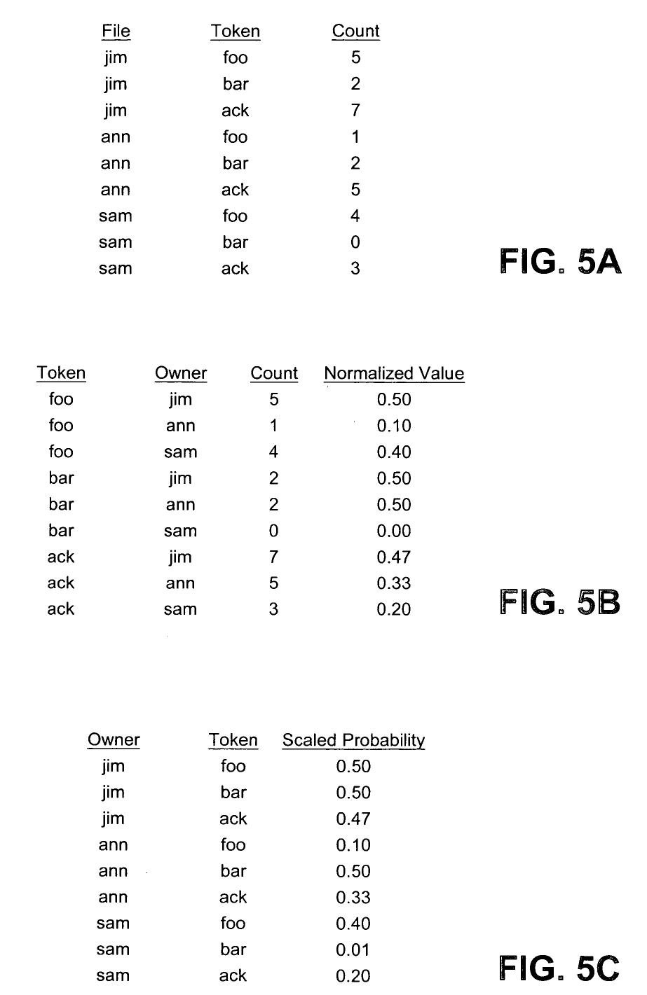

Once all owner files have been created, the derivative database generator 120 stores the owner files in a database, i.e., the derivative database (assuming the derivative database did not already exist), as indicated in block 308. At this point, the derivative database is available for use in making ownership determinations (i.e., probability determinations) using the ownership calculator 122 (see FIGS. 4A and 4B). An example of the contents of a derivative database is conceptually illustrated by the table of FIG. 5A. As indicated in that table, three files, “jim,” “ann,” and “sam,” which pertain to three owners, Jim, Ann, and Sam, are included in the derivative database. In addition, the derivative database includes the number of occurrences for each of tokens “foo,” “bar,” and “ack,” as to each owner. For instance, the number of occurrences of the token “foo” for Jim is 5. Notably, the actual configuration and structuring of the derivative database is unimportant. Generally speaking, the derivative database comprises an associative array that associates owners with tokens and the number of occurrences of those tokens on a per-owner basis.

FIGS. 4A and 4B illustrate an example of operation of the ownership calculator 122 in providing an indication as to the probability of ownership of a given bug in relation to a pool of potential owners (i.e., the owners provisionally identified in the derivative database). Beginning with block 400 of FIG. 4A, the ownership calculator 122 is initiated. Such initiation typically occurs when the calculator 122 is called upon by an operator to provide an indication as to the likely owner of a particular bug. Once initiated, the ownership calculator 122 receives information regarding the bug for which the ownership determination is to be made, as indicated in block 402. By way of example, that information can comprise a file that contains a description of the bug. In some embodiments, such a file may comprise all or a portion of the body of a bug record contained in the bug database. Alternatively or in addition, the information may comprise information that was copied from an error message that the operator received and/or data results that were generated by the program at issue. Irrespective of the origin of the information, the information is pertinent to the bug in question and therefore may be used as a reference (i.e., search query) in determining who might own the bug.

With reference next to block 404, the ownership calculator 122 generates input tokens that are derived from the character stings of the information that was input into the calculator. In some embodiments, the input tokens are generated using the same rules that were used to generate the tokens contained in the derivative database (see the discussion of FIG. 3). Therefore, tokens may only be generated for strings of characters that comprise letters, numbers, and/or underscores and that are not shorter or longer than predetermined thresholds. Once the input tokens have been generated, the ownership calculator 122 searches the owner files of the derivative database to identify occurrences of the input tokens as to each owner, as indicated in block 406. From that identification, the ownership calculator 122 can further determine the number of occurrences of each token as to each owner, as indicated in block 408. That determination is made by simply reading the count contained in the derivative database as to each token.

Next, as indicated in block 410, the ownership calculator 122 sums the total number of occurrences as to each token across the entire derivative database. Such summing can be accomplished by simply adding together the counts as to each token for all owners. In keeping with the example data contained in the table of FIG. 5A (which conceptually illustrates the contents of an example derivative database), the total counts for the three identified tokens are: foo=10, bar=4, and ack=15. Once those totals have been determined, the calculator 122 normalizes the number of occurrences of each token relative to each owner, as indicated in block 412 of FIG. 4B. Such normalization comprises dividing the total number of occurrences for each token as to each given owner by the total number of occurrences for the token across all owners. The normalized values that result comprise probabilities as to the given owner actually owning the bug in relation to each individual token. FIG. 5B conceptually illustrates the results of the above-described normalization process on the data contained in the table of FIG. 5A. As indicated in FIG. 5B, the normalized values (i.e., probabilities) for Jim as to each input token are: foo=0.50, bar=0.50 and ack=0.47; for Ann are foo=0.10, bar=0.50, and ack=0.33; and for Sam are foo=0.40, bar=0.00, and ack=0.20. To determine the overall probability, however, all tokens and all owners must be taken into account (see discussion below).

Referring next to block 414, the normalized values (probabilities) are scaled to obtain scaled probabilities as to each token/owner pair. This scaling is performed to avoid skewing the overall probability determination. In this scaling, extremely low (near zero) and high (near one) normalized values are adjusted to reduce their impact on the overall probability determination. For instance, any normalized value that is less than 0.01 can be assigned a value of 0.01, and any normalized value that is greater than 0.99 can be assigned a value of 0.99. In addition, if any given input token is not found for any of the owners (i.e., it is not contained in the derivative database at all), the normalized value for that token for each owner can be assigned a nearly neutral, but negatively-biased value, such as 0.40. Results of such scaling on the data of FIG. 5B are indicated in FIG. 5C. As shown in that figure, the “0.00” value for Sam in relation to the “bar” function has been changed to “0.01” through application of the rules described above.

At this point, the ownership calculator 122 may determine the standard deviation of the scaled probabilities, as indicated in block 416, to potentially reduce the field of possible tokens to be considered for an owner in the overall probability determination. To determine the deviation, the absolute value of each scaled probability minus 0.50 is calculated. If the result of that calculation is less than a predetermined minimum deviation value, the token associated with the scaled probability may be removed from the list of tokens to be considered for the overall probability determination, as indicated in block 418. For instance, if the minimum deviation value were set to 0.10, each token having a probability value between 0.40 and 0.60 would be removed from consideration. Notably, for purposes of the present example and later overall probability calculation, none of the tokens for the three example owners, Jim, Ann, or Sam will be removed from the list of tokens to be considered (i.e., the minimum deviation equals zero).

With reference to block 420, the overall probability of ownership of the bug in question can next be determined as to each owner. Various different analytical and/or statistical tools can be used to make that determination. One such tool is Bayes' Theorem. Bayes' Theorem, as applied in this context, may be described as to each owner in equation form as the following:

$$Po = \frac{( product of scaled probabilities )}{( product of scaled probabilities ) + ( product of inverse probabilities )} \qquad [ Equation 1 ]$$

where P_{O} is the overall probability of that person owning the bug in question, the “scaled probabilities” are the scaled, normalized values, and the “inverse probabilities” are equal to the result of subtracting the scaled probabilities from 1 as to each owner. Applying that equation for each of the example owners from FIGS. 5A-5C we obtain the following:

$$\begin{matrix}\begin{matrix}{P}_{o} = ( 0.50 ) ( 0.50 ) ( 0.47 ) / ( ( 0.50 ) ( 0.50 ) ( 0.47 ) + ( 0.50 ) ( 0.50 ) ( 0.53 ) ) \\ = 0.4700\end{matrix} & Jim \text{:} \\ \begin{matrix}{P}_{o} = ( 0.10 ) ( 0.50 ) ( 0.33 ) / ( ( 0.10 ) ( 0.50 ) ( 0.33 ) + ( 0.90 ) ( 0.50 ) ( 0.67 ) ) \\ = 0.0052\end{matrix} & Ann \text{:} \\ \begin{matrix}{P}_{o} = ( 0.40 ) ( 0.01 ) ( 0.20 ) / ( ( 0.40 ) ( 0.01 ) ( 0.20 ) + ( 0.60 ) ( 0.99 ) ( 0.80 ) ) \\ = 0.0013\end{matrix} & Sam \text{:}\end{matrix}$$

Once the overall probabilities, P_{O}, have been determined as to each owner, they can be presented to the user, for instance in a display device or as a print out. By way of example, a list of the most likely owners of the bug in question can be presented to the user, as indicated in block 422. Such a list can comprise, for instance, the top three to five owners as ranked by the overall probabilities from largest to smallest. In the above example, it appears clear that Jim is the likely owner of the bug in that his overall probability number (0.4700) far exceeds those of Ann and Sam. Although not all results will so obviously indicate who the most likely owner is, the results will at minimum provide an indication that the user can consider in making his or her own determination as to who the true bug owner is. For example, the user can use the results provided by the ownership calculator 122 as a guide in his or her continued investigation as to who the likely owner is. Therefore, the disclosed systems and methods may be considered tools available to users in making the ownership determination.

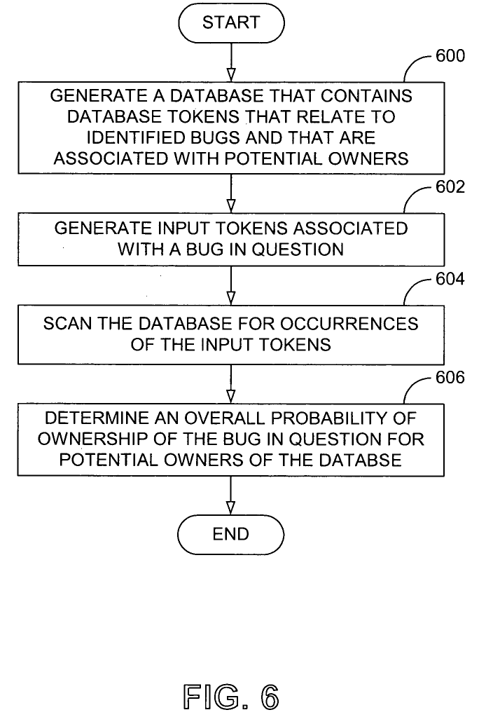

In view of the above, an embodiment for determining bug ownership is shown in the flow diagram of FIG. 6. As provided in FIG. 6, that method comprises generating a database that contains database tokens that relate to identified bugs and that are associated with potential owners (block 600), generating input tokens associated with a bug in question (block 602), scanning the database for occurrences of the input tokens (block 604), and determining an overall probability of ownership of the bug in question for potential owners of the database (block 606).

1. A method for determining bug ownership, comprising:
generating a database that contains database tokens that relate to identified bugs and that are associated with potential owners;
generating input tokens associated with a bug in question;
scanning the database for occurrences of the input tokens; and
determining an overall probability of ownership of the bug in question for potential owners in the database.

2. The method of claim 1, wherein generating a database comprises generating a derivative database from a bug database that contains bug records with which potential owners are associated.

3. The method of claim 2, wherein generating a derivative database comprises generating database tokens from character strings of the bug records.

4. The method of claim 3, wherein generating database tokens comprises generating tokens for character strings that comprise at least one of letters, numbers, and underscores.

5. The method of claim 3, wherein generating database tokens further comprises noting the number of times each input token occurs relative to each potential owner of the bug in question.

6. The method of claim 1, wherein generating input tokens comprises generating tokens from character strings of a bug input.

7. The method of claim 1, wherein generating input tokens comprises generating tokens for character strings that comprise at least one of letters, numbers, and underscores.

8. The method of claim 1, wherein scanning the database comprises scanning the database tokens to identify matches for the input tokens.

9. The method of claim 1, wherein scanning the database further comprises identifying the number of occurrences of each input token in the database relative to each potential owner of the bug in question.

10. The method of claim 1, wherein determining the overall probability of ownership comprises summing the total number of occurrences of each input token in the database and normalizing the total number of occurrences of each input token as to each potential owner of the bug in question.

11. The method of claim 10, wherein determining the overall probability of ownership further comprises scaling normalized values that result from the normalizing to obtain scaled probabilities as to each input token relative to each potential owner in the database.

12. The method of claim 11, wherein determining the overall probability of ownership further comprises determining the standard deviance for each scaled probability and removing owner tokens from consideration that are associated with an input token having a deviance below a predetermined minimum deviance.

13. The method of claim 12, wherein determining the overall probability of ownership further comprises determining the overall probability of ownership as to all potential owners using the scaled probabilities associated with those owners.

14. The method of claim 13, wherein determining the overall probability of ownership as to all potential owners comprises applying Bayes' Theorem to the scaled probabilities of the potential owners to calculate the overall probability for each potential owner of owning the bug in question.

15. A system for determining bug ownership, comprising:
means for generating input tokens associated with a bug in question;
means for scanning a database that associates potential owners with database tokens pertaining to bugs that the owners may own for occurrences of the input tokens; and
means for determining an overall probability of ownership of the bug in question for potential owners of the database.

16. The system of claim 15, wherein the means for generating input tokens comprise means for generating tokens from character strings of an input entered by a user.

17. The system of claim 15, wherein the means for scanning a database comprise means for scanning the database tokens to identify matches for the input tokens and means for identifying the number of occurrences of the input tokens in the database relative to each potential owner.

18. The system of claim 15, wherein the means for determining the overall probability of ownership comprise means for determining a probability of ownership as to each potential owner relative to each database token associated with those owners.

19. The system of claim 18, wherein the means for determining the overall probability of ownership further comprise means for determining the overall probability of ownership as to the potential owners using the determined probabilities as to each input token.

20. The system of claim 19, wherein the means for determining the overall probability of ownership as to the potential owners using the determined probabilities comprise means for applying Bayes' Theorem to those probabilities to calculate the overall probability for each potential owner of owning the bug in question.

21. The system of claim 15, further comprising means for generating the database from bug records contained in a bug database.

22. A system stored on a computer-readable medium, the system comprising:
logic configured to generate a database that associates potential owners with database tokens that pertain to bug records;
logic configured to generate input tokens from an input that describes a bug in question;
logic configured to identify the number of occurrences of each of the input tokens in the database as per each potential owner; and
logic configured to determine an overall probability of ownership of the bug in question for the potential owners relative to the number of occurrences.

23. The system of claim 22, wherein the logic configured to generate a database is configured to generate database tokens from character strings of bug records of a bug database and note the number of occurrences of each database token relative to each potential owner.

24. The system of claim 22, wherein the logic configured to generate input tokens is configured to generate tokens from character strings of an input file.

25. The system of claim 22, wherein the logic configured to determine the overall probability of ownership is configured to determine probabilities of ownership as to each potential owner relative to database tokens associated with those owners.

26. The system of claim 25, wherein the logic configured to determine the overall probability of ownership is further configured to determine the overall probability of ownership as to the potential owners using the determined probabilities.

27. The system of claim 22, wherein the logic configured to determine the overall probability of ownership is further configured to apply Bayes' Theorem to the determined probabilities to calculate the overall probability for each potential owner of owning the bug in question.

28. A bug ownership system stored on a computer-readable medium, the system comprising:
a derivative database generator that is configured to generate a derivative database that contains a plurality of database tokens that are associated with potential owners; and
an ownership calculator that is configured to:
generate input tokens from an input that describes a bug in question,
determine the number of occurrences of the input tokens in the derivative database relative to each potential owner,
determine the probability of ownership of the bug in question for each potential owner relative to each input token, and
calculate an overall probability of ownership of the bug in question for each potential owner using the determined probabilities.

29. The system of claim 28, wherein the derivative database generator is configured to generate database tokens from character strings contained in bug records of a bug database.

30. The system of claim 28, wherein the ownership calculator is configured to calculate the overall probability by applying Bayes' Theorem to the determined probabilities.

31. A computer system, comprising:
a processing device; and
a memory that comprises a bug ownership system, the bug ownership system being configured to generate a first set of tokens for each of several potential owners, generate input tokens from an input that describes a bug in question, determine the number of occurrences of the input tokens in the first sets of tokens, determine the probability of ownership of the bug in question for each potential owner relative to each input token, and calculate an overall probability of ownership of the bug in question for each potential owner using the determined probabilities.

32. The system of claim 31, wherein the bug ownership system is configured to calculate the overall probability by applying Bayes' Theorem to the determined probabilities.
